(19) United States
(12) Patent Application Publication
(10) Pub. No.: US 2022/0333632 A1
(43) Pub. Date: Oct. 20, 2022

(54) Hidden recess furniture screw and driver system

(71) Applicant: Andrew J. Klein, Parker, CO (US)

(72) Inventor: Andrew J. Klein, Parker, CO (US)

(21) Appl. No.: 17/722,043

(22) Filed: Apr. 15, 2022

Related U.S. Application Data
(60) Provisional application No. 63/176,020, filed on Apr. 16, 2021.

(51) Int. Cl. F16B 23/00; F16B 12/10; B25B 15/00; B25B 23/12

(52) U.S. Cl. CPC F16B 23/0015; F16B 12/10; B25B 15/007; B25B 23/12

(57) ABSTRACT

A fastener and a specialized driver for use in furniture or shelving assembly where the fastener comprises a fastener head with an aperture centered therein and a fastener body extending from connection with the fastener head, the fastener body having an interior cavity along a length of the fastener body. A spring biased plunger is slidable within an interior cavity of the fastener body between a first position where the plunger has a surface configured to fit within the aperture and in a second position the plunger is spaced apart from the aperture. The driver is removably couplable to the fastener to depress the plunger and transfer torque to the fastener for installation. After installation, the plunger resumes a position plugging the aperture and the tolerance between the plunger and the aperture is sufficiently tight to effectively obscure any seam between the plunger and the aperture such that the fastener head surface appears continuous.

### CROSS-REFERENCE TO RELATED APPLICATIONS

This application is based on and claims the benefit of U.S. provisional application Ser. No. 63/176,020, filed Apr. 16, 2021, the content of which is hereby incorporated in its entirety.

### BACKGROUND

The present invention relates to a decorative screw fastener. More specifically this disclosure relates to a screw fastener that displays an unbroken flat disc because the driver recess is only revealed when a specialized driver depresses a center plunger, and locks into place with magnets. In this way a decorative aesthetic is achieved while the functionality of a screw fastener is maintained.

Numerous decorative fasteners for furniture exist, but none of these fasteners present a flat unbroken circular top when installed as such a fastener has no surface for a driver to couple to or connect with.

### SUMMARY

An aspect of the present disclosure relates to a fastener for use in furniture or shelving assembly. The fastener has a fastener body having a fastener head, the fastener head comprising an aperture centered therein and the fastener body having an interior cavity along a length of the fastener body. A spring biased plunger is slidable within an interior cavity of the fastener body and in a first position the plunger has a surface configured to fit within the aperture and in a second position the plunger is pushed out of the aperture.

The fastener body is externally threaded along its length.

The spring biased plunger has the surface configured to fit within the aperture with a tolerance sufficient to substantially obscure a seam between the plunger and the aperture to provide a substantially smooth and flat fastener head when the plunger is in the first position.

The aperture of the fastener head is configured to receive a driver head therein to depress the spring biased plunger to the second position and move the fastener into a substrate for assembly or installation of the furniture or shelving assembly.

The aperture of the fastener head is configured to receive a driver head therein to depress the spring biased plunger to the second position and rotate the fastener to drive the fastener into a substrate for assembly or installation of the furniture or shelving assembly.

The spring biased plunger comprises a disk and a plug extending therefrom and wherein the disk has a perimeter dimension greater than the perimeter dimension of the plug to retain the plunger within the interior cavity.

The fastener is machined from a metal block by a Wire EDM process.

Another aspect of the present disclosure relates to a fastener system. The fastener system includes a fastener having a fastener body having a fastener head, the fastener head comprising an aperture centered therein and the fastener body having an interior cavity along a length of the fastener body with a spring biased plunger slidable within an interior cavity of the fastener body. In a first position, the plunger has a surface configured to fit within the aperture and in a second position the plunger is pushed out of the aperture. The system further includes a driver having a handle end and a driver head with a shaft extending therebetween. The driver head comprises a protrusion having dimensions such that the protrusion is removably couplable to the aperture of the fastener head wherein the driver is removably couplable to the fastener.

The driver head further comprises one or more magnets for removably coupling the driver to the fastener.

Another aspect of the present disclosure relates to a method of assembling furniture or shelving. The furniture or shelving is assembled by inserting a threaded end of a fastener into a substrate. Coupling a driver head of a driver to a fastener head of the fastener and depressing a plunger from an aperture of the fastener head and into the threaded end of the fastener with the driver head allows for rotating the driver to secure the fastener in the substrate. Uncoupling the driver head from the fastener head allows the plunger to travel back into connection with the aperture of the fastener head such that the plunger fits into an aperture to provide the appearance of a smooth and flat fastener head and flush with a surface of the substrate.

### BRIEF DESCRIPTION OF THE DRAWINGS

FIG. 1 is perspective view of a fastener system.

FIG. 2 is an exploded view of a fastener of the fastener system.

FIG. 3 is a perspective view of the fastener installed in a furniture construction.

### DETAILED DESCRIPTION

A fastener system comprising a fastener and a driver is described herein. The fastener comprises a threaded section fixed to a top portion, or fastener head, and a spring-loaded plunger held within a length of the threaded section, fills a center driver hole in the top portion when at rest. When the specialized driver is coupled to the top portion and pushed against the plunger, the plunger compresses the spring, and a driver recess that engages with a driver head of the driver is revealed. This recess allows for coupling of the driver and the fastener and the transfer of torque from the driver to the fastener, allowing the fastener to be threaded into place. Magnets may be recessed into the driver head to hold the driver in place on the fastener as it is used.

The size and shape of the driver recess created by the depressed plunger is not limited to a simple slot, and could be complex gear or star shapes, or any aesthetically pleasing shape adding further to the decorative nature of the fastener system.

Tolerances between an inner perimeter of the recess on the fastener head and an outer perimeter of a surface of the plunger can be sufficiently tight such that a seam between the plunger and the screw head disappears when the plunger is pushed by the spring back into place within the recess after the driver is removed. These tight tolerances can be achieved by forming the fastener and the plunger with ultra-precision manufacturing processes like Wire electrical discharge machining, or Wire EDM. The resulting functionality and look of the fastener according to embodiments described herein allows the fastener system to be used with a high end, flat pack furniture line, shelving units, or various other furniture and/or decorative or functional installations.

One embodiment of the fastener system 10 is illustrated generally in the figures. The system comprises a fastener 12 and a driver 14 that can be used in the construction of furniture 22, shelving units or various other installations and the like.

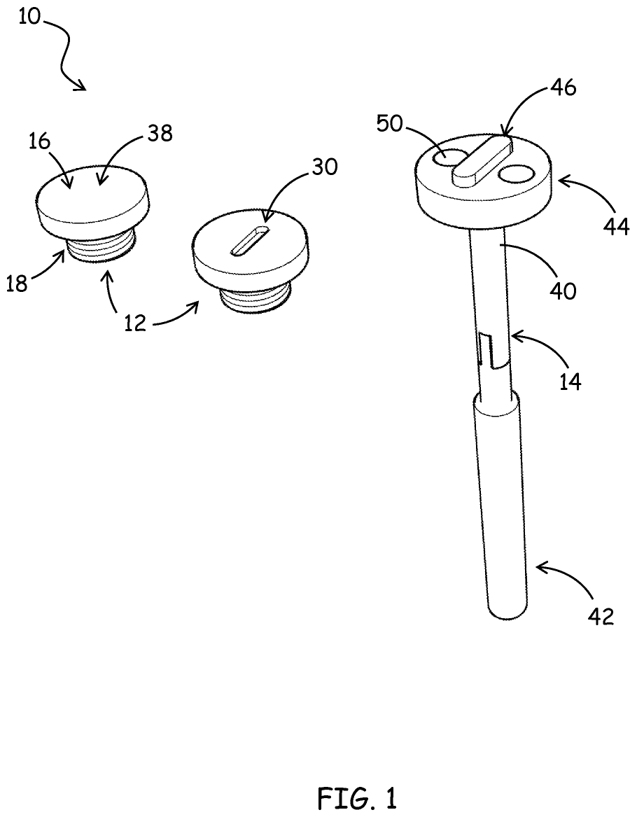

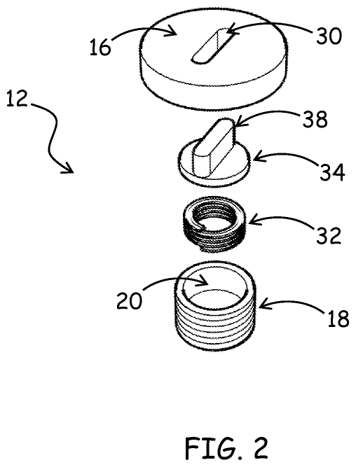

As illustrated in FIGS. 1-2, the fastener 12 may be a threaded fastener such as a screw. In the embodiment illustrated, the fastener comprises a fastener head 16 and a threaded length 18 extending from connection with the fastener head 16. The fastener head 16 may be a disk having a head thickness 18 and a head diameter 20. While the fastener head 16 illustrated is circular in shape, other geometric shapes for the base are contemplated and within the scope of this disclosure. In the embodiment illustrated, the fastener 12 is configured for installation in a flat, or substantially flush manner, where the fastener is installed in a manner that it is flush with a surface of a substrate in which the fastener 12 is installed. In other decorative installations, the fastener may be installed in a manner wherein the fastener head sits above the substrate and thus alternative geometric shapes for the fastener head are contemplated and within the scope of this disclosure.

Extending outwardly from a bottom surface of the fastener head 16 is the threaded length 18. The threaded length 18 is externally threaded with an open inner cavity 20 along its length. The threaded length 18 may also be open at a terminal end opposite the fastener head 16. The threaded length 18 has an outer diameter. In the embodiment illustrated, the outer diameter is less than the fastener head diameter. The fastener head 16 may also have an aperture 30 which is configured to removably couple the fastener 12 to the driver 14 for installation and/or removal of the fastener 12. In the embodiment illustrated, the aperture 30 is an elongated slot, however, alternative shapes for the aperture 30 are contemplated and within the scope of this disclosure.

The fastener system 10 further comprises a spring 32 and a plunger 34. The spring 32 and plunger 34 are configured to fit inside the open inner cavity 20 of the threaded length 18 of the fastener 12. The spring 32 is a compression spring and serves to aid in positioning and movement of the plunger 34. The spring 32 has dimensions that allow the spring to fit within the inner cavity 20 and compress and relax therein. The plunger 34 is a disk having a diameter and a protrusion 38 also referred to as a plug 38, on an outer surface of the disk wherein the protrusion 38 has perimeter dimensions that match the inner dimension of the aperture 30 in the fastener 12. The tolerance between the perimeter of the plug 38 and the inner surface of the aperture 30 are sufficiently tight to obscure any seam when the plug 38 is engaged in the aperture 30 and thus the top surface of the fastener head 16 is substantially smooth and flat.

The driver 14 is configured to install the fastener 12 for use. Thus, the driver 14 is configured to removably couple to the fastener 12 and provide torque to the fastener 12. The driver 14 has a shaft 40 extending between a grip end 42 and a driver head 44. The grip end 42 may have a textured end, handle, or other end effector allowing a user to grab and use the driver 14. The driver head 44 may be a disk having dimensions similar to the fastener head 16 for coupling the driver head to the fastener head. The driver head 44 has a protrusion 46 extending outwardly from the driver head 44. The protrusion 46 has dimensions, such as a height and outer perimeter shape which allow the protrusion 46 to fit into and mate with the aperture 30 in the fastener 12.

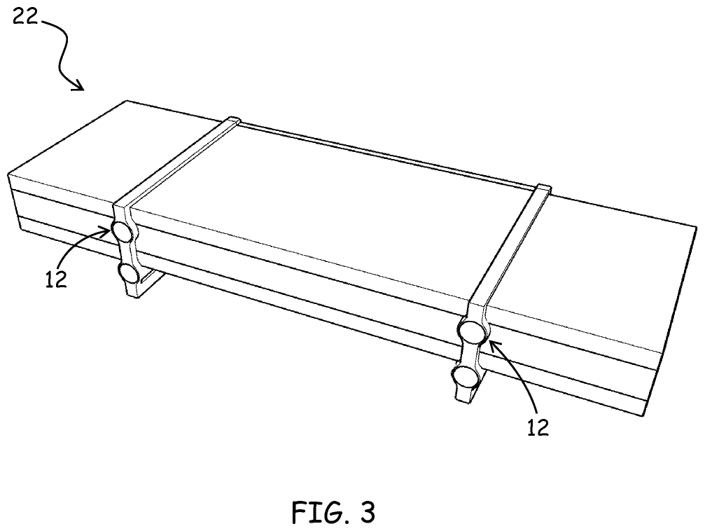

When inserted into the fastener head 16, the protrusion 46 catches and couples to the aperture 30, allowing rotation of the driver 14 to rotate the fastener 12 via frictional engagement. The protrusion 46 may also push down the plunger 34, moving the plunger 34 into the inner cavity 20 along the threaded length 18 and concurrently compressing the spring 32 while driving the fastener 12 into a substrate for installation of the fastener 12. When the fastener 12 is installed, the driver 14 is uncoupled from the fastener 12 and the protrusion 46 removed from the aperture 30. As the driver 14 is uncoupled from the fastener head 16, the spring 32 relaxes and pushes against the plunger 34 to push the plunger 34 towards to fastener head 16 and thus move the plug 38 into the aperture 30 providing the substantially smooth and flat outer surface of the fastener head 16 as illustrated in FIG. 3. As the seam between the aperture 30 and the plug 38 is substantially obscured, the fastener head 16 appears as a solid, singular object.

The driver 14 may additionally couple to the fastener. In the embodiment illustrated, the driver head 44 is provided with one or more magnets 50 to magnetically couple the driver 14 to the fastener 12.

The fastener 12 and plunger 34 may be comprised of aluminum, steel, stainless steel, titanium, or a like metal or metal alloy. The driver head 44 may be similarly constructed.

Although the present disclosure has been described with reference to preferred embodiments, workers skilled in the art will recognize that changes may be made in form and detail without departing from the spirit and scope of the disclosure.

1. A fastener for use in furniture or shelving assembly, the fastener comprising:
a fastener body having a fastener head, the fastener head comprising an aperture centered therein and the fastener body having an interior cavity along a length of the fastener body; and
a spring biased plunger slidable within the interior cavity of the fastener body wherein in a first position the plunger has a surface configured to fit within the aperture and in a second position the plunger is pushed out of the aperture.

2. The fastener of claim 1 wherein the fastener body is externally threaded along the length.

3. The fastener of claim 1 wherein the spring biased plunger has the surface configured to fit within the aperture with a tolerance sufficient to substantially obscure a seam between the plunger and the aperture to provide a substantially smooth and flat fastener head when the plunger is in the first position.

4. The fastener of claim 1 wherein the aperture of the fastener head is configured to receive a driver head therein to depress the spring biased plunger to the second position and move the fastener into a substrate for assembly or installation of the furniture or shelving assembly.

5. The fastener of claim 2 wherein the aperture of the fastener head is configured to receive a driver head therein to depress the spring biased plunger to the second position and rotate the fastener to drive the fastener into a substrate for assembly or installation of the furniture or shelving assembly.

6. The fastener of claim 1 wherein the spring biased plunger comprises a disk and a plug extending therefrom and wherein the disk has a perimeter dimension greater than the perimeter dimension of the plug to retain the plunger within the interior cavity.

7. The fastener of claim 1 wherein the fastener is machined from a metal block by a Wire EDM process.

8. A fastener system comprising:
a fastener comprising:
a fastener body having a fastener head, the fastener head comprising an aperture centered therein and the fastener body having an interior cavity along a length of the fastener body; and
a spring biased plunger slidable within an interior cavity of the fastener body wherein in a first position the plunger has a surface configured to fit within the aperture and in a second position the plunger is pushed out of the aperture; and
a driver comprising:
a handle end and a driver head with a shaft extending therebetween and wherein the driver head comprises a protrusion having dimensions such that the protrusion is removably couplable to the aperture of the fastener head wherein the driver is removably couplable to fastener.

9. The fastener system of claim 8 and wherein the driver head further comprises one or more magnets for removably coupling the driver to the fastener.

10. A method of assembling furniture or shelving comprising:
inserting a threaded end of a fastener into a substrate;
coupling a driver head of a driver to a fastener head of the fastener and depressing a plunger from an aperture of the fastener head and into the threaded end of the fastener with the driver head;
rotating the driver to secure the fastener in the substrate;
uncoupling the driver head from the fastener head; and
allowing the plunger to travel back into connection with the aperture of the fastener head such that the plunger fits into an aperture to provide the appearance of a smooth and flat fastener head and flush with a surface of the substate.
